(19) United States
(12) Patent Application Publication
(10) Pub. No.: US 2007/0094163 A1
(43) Pub. Date: Apr. 26, 2007

(54) Genetic algorithm-based tuning engine

(76) Inventors: Guy F. Bowerman, Portland, OR (US); Kevin L. Beck, Portland, OR (US)

Correspondence Address: WALTER W. DUFT, 8616 MAIN STREET, SUITE 2, WILLIAMSVILLE, NY, 14221, US

(21) Appl. No.: 11/214,284

(22) Filed: Aug. 29, 2005

(51) Int. Cl. G06N 3/12

(52) U.S. Cl. 706/13

(57) ABSTRACT

A system, method and computer program product for tuning the performance of a software system. A generation of genomes is created that each represents a set of unique tunable parameter values (genes) associated with the software system. The software system is selectively configured with the genomes and executed to produce a score. Genomes that have produced meritorious scores are combined to serve as parent genomes for the creation of a next generation of child genomes having genes selected from each parent genome. The execution, scoring and parent selection cycle repeats for each new generation until performance tuning has completed.

### BACKGROUND OF THE INVENTION

1. Field of the Invention

The present invention relates to computer software systems. More particularly, the invention concerns techniques for tuning configurable operational parameters for improved software performance.

2. Description of the Prior Art

By way of background, many computer software systems have configurable operational parameters that allow the software to be tuned for improved performance according to anticipated runtime conditions. Database management systems are one example of such software. Database management systems are often subject to changing workloads, query types, user activity, etc. For example, in a real-time data warehouse environment, it is relatively easy to overload a database management server with too many users, too much memory utilization, and poor caching effects due to the large amount of data being referenced. Static environmental and control parameter settings are thus available to enable database administrators to indirectly affect the critical execution paths and semantics of the database management server as database resources, workloads and users change. For example, as the number of database users increases or achieves some threshold value, a database administrator might want to change the concurrency control optimizations to favor high concurrency. Similarly, if it is recognized that a particular user or a particular query is extremely important, the database administrator might want to assign a set of run-time parameters that optimizes the run-time environment for that particular user or that particular query. Assuming the original optimization was designed to support routine online transaction processing (OLTP) requests in which relatively few database records need to be processed with sub-second response time, the optimization could be changed to support ad hoc processor-intensive decision support system (DSS) requests requiring hours to complete.

Unfortunately, the performance tuning of computer software as large and complex as a database management system is often a trial and error process. Typically, a human database performance expert (e.g., the database administrator) can only make reasonable estimations for setting the tunable parameters in order to optimize throughput for the specific task at hand. The performance expert then runs tests based on the selected parameters, evaluates the results, and makes further parameter adjustments. This cycle many need to be repeated several times, consuming inordinate amounts of time and human/machine resources.

It is to improvements in the area of computer software tuning that the present invention is directed. In particular, what is needed is an automated tool that can manipulate the tunable operational parameters of a software system in order to optimize system performance relative to a particular objective.

### SUMMARY OF THE INVENTION

The foregoing problems are solved and an advance in the art is obtained by a novel system, method and computer program product for tuning the performance of a software system. A generation of genomes is created that each represents a set of unique tunable parameter values (genes) associated with the software system. The software system is selectively configured with the genomes and executed to produce a score. Genomes that have produced meritorious scores are combined to serve as parent genomes for the creation of a next generation of child genomes having genes selected from each parent genome. The execution, scoring and parent selection cycle repeats for each new generation until performance tuning has completed.

In a disclosed exemplary embodiment of the invention, a genetic algorithm engine is used to iteratively produce multiple generations of genomes and provide the genomes to a configuration module that configures the software system for execution of a test program to produce scores corresponding to each generation of genomes. The configuration module can be adapted to produce a stored set of last generation scores associated with a most recently executed generation of genomes and to select and store a set of one or more cumulative top scores. The genetic algorithm engine may include a parent selector that selects parent genomes from one or both of the last generation score sets and the cumulative top score sets. The genetic algorithm engine may further include a combiner adapted to create child genomes from the parent genomes by selecting genes from each of the parent genomes. The genetic algorithm engine may additionally include a rule set processor that is adapted to inspect the child genomes and modify genes thereof that violate established rules. The genetic algorithm engine may also include a uniqueness filter adapted to screen for child genomes having duplicate gene sets. The genetic algorithm engine may also include a mutator that is adapted to produce mutations of the child genomes by varying genes that comprise the child genomes.

### BRIEF DESCRIPTION OF THE DRAWINGS

The foregoing and other features and advantages of the invention will be apparent from the following more particular description of an exemplary embodiment of the invention, as illustrated in the accompanying Drawings, in which:

FIG. 1 is a functional block and flow diagram showing a genetic algorithm-based tuning engine adapted to optimize the run-time characteristics of a software system according to desired performance objective; and

FIG. 2 is a functional block and flow diagram showing details of an offspring generator associated with the genetic algorithm-based tuning engine of FIG. 1.

### DETAILED DESCRIPTION OF EXEMPLARY EMBODIMENT

1. Introduction

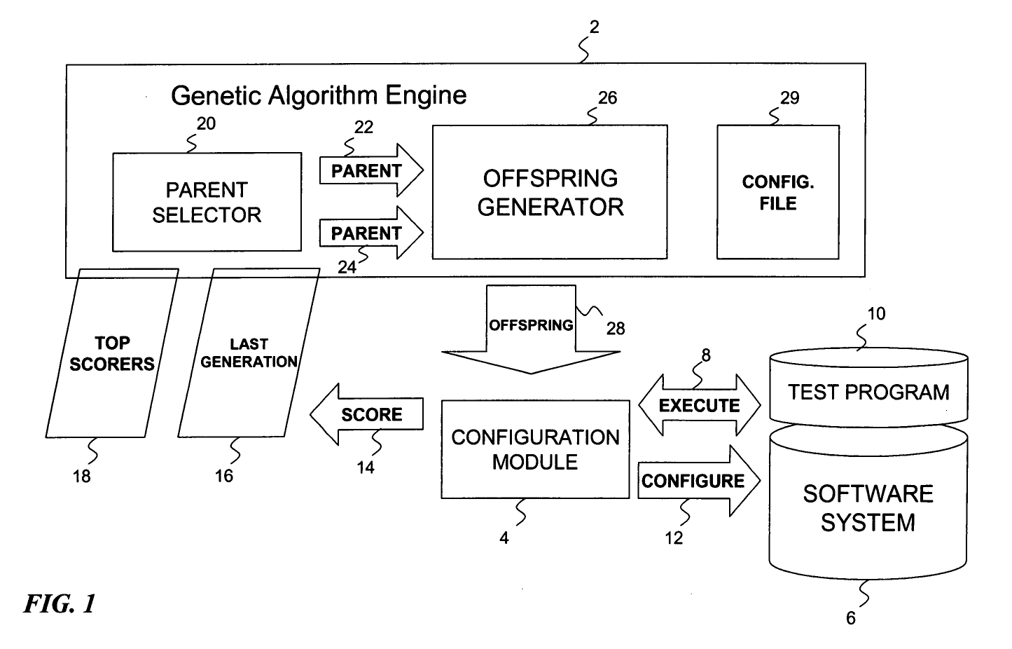

Turning now to the drawing figures wherein like reference numbers indicate like elements in all of the several views, FIG. 1 illustrates a genetic algorithm-based tuning engine 2 (genetic algorithm engine) that operates in association with a configuration module 4 to optimize a software system 6 to achieve a specified performance goal. The tuning engine 2 uses principals of inheritance, mutation and natural selection to explore a search space of tunable operational parameters associated with the software system 6 to discover an optimum set of parameter values. Starting with an initial “genome” representing the tunable parameters to be adjusted, the genetic algorithm engine 2 interfaces with the configuration module 4 to execute (8) a series of tests on the software system 6 using a performance test program (module) 10. The configuration module 4 dynamically configures (12) the software system 6 prior to each test using genomes generated by the genetic algorithm engine 2. Each genome has semi-random variations of parameter values associated therewith over a prescribed range. Each test is thus run with a genome comprising a unique set of tunable parameters whose values are different from the genomes used for other tests. A score output 14 is produced by each execution of the test program 10 for each genome used to configure the software system 6. Each of the scores 14 represents a numerical evaluation of the performance or fitness of a genome used for a given test. The scored parameter sets are stored as part of a “last” generation 16 of genomes maintained by the genetic algorithm engine 2. The genetic algorithm engine 2 processes the scores associated with each genome comprising the last generation 16 and selects the top scorers 18 representing the most promising genomes to serve as a pool of potential “parents” for a next generation of genomes. A parent selector 20 associated with the genetic algorithm engine 2 selects two genomes to serve as parents 22 (parent x) and 24 (parent y). For each generation, several sets of parents 22-24 may be selected to produce the offspring that comprise the next generation. In order to promote a “survival of the fittest” evolutionary track, different parent pairings 22-24 may be made based on selection of the most suitable (best performing) parents. For example, one parent pairing 22-24 might combine the all-time highest performing genome with the highest performing genome of the last generation (elite selection strategy). Another parent pairing 22-24 might combine the second highest performing genome of the last generation with the highest performing genome of the last generation. Still another parent pairing 22-24 might combine the third highest performing genome of the last generation with the highest performing genome of the last generation, and so on. Each set of parent genomes 22 and 24 is used as input to an offspring generator 26 associated with the genetic algorithm engine 2. As described in more detail below, the function of the offspring generator 26 is to select parameter values from each parent 22 and 24 and crossover-combine these values to generate offspring genomes 28 that are used to begin a new generation of testing. Each parent pair 22-24 can result in multiple children, depending on the genome configuration parameters and how they are mutated (see below). For example, the genetic algorithm engine 2 could be programmed to select three pairs of parents 22-24 and each such pair could provide the genetic template for producing four children. This would result in twelve child genomes being created for testing in the next generation. Additional generations (using the “fittest” genomes as parents for each new generation in combination with random optimization) can be run up to a pre-defined number of generations or until the achievement of a specific performance goal. This multigenerational process is akin to a random restart hill climbing algorithm with each generation producing local maxima genomes that are saved, randomized, and tested in order to explore the tunable parameter search space of the software system 6 in order to discover a most fit genome.

The foregoing procedure advantageously automates the refinement stage of performance tuning, wherein parameter values are tested, evaluated and optimized. This automation is particularly applicable in situations that have a clearly defined problem, human time is limited and machine time is plentiful. One exemplary scenario would be a database management system that needs to be tuned to run a particular job and data processing resources are available to run the genetic algorithm engine 2 and the database system (as the software system 6). In this scenario, the test program 10 could be repeatedly run while varying the tunable parameters of the database system to home in on the optimum settings. Optionally, a performance expert could define in advance a narrow range of parameter values to be varied, thus reducing the required testing time.

2. Exemplary Mode of Operation

The genetic algorithm engine 2 may be implemented as a software application running on any suitable data processing system managed by any desired operating system. The software system 6 can be any software whose operational characteristics are governed in whole or in part by tunable parameters. By way of example only, and not by limitation, the software system 6 could be a database management program, such as the IBM® DB2® Database Management System. The software system 6 could run on the same data processing system as the genetic algorithm engine 2, or it could run on a separate system. The configuration module 4 is called by the genetic algorithm engine 2 in order to set the parameters of the software system 6 according to the values of a genome's specified parameter set. Depending on the implementation of the genetic algorithm engine 2, the configuration module 4 could be a dynamic link library (DLL) or shared library, a Java® archive, or a separate process that communicates with the genetic algorithm engine via inter-process communication. The configuration module 4 accesses automation APIs (automated program interfaces) exposed by the software system 6 for setting the software system's tunable parameters. Typically, such automation APIs will be accessible via conventional COM (component object model) or Java interface tools. Other interfaces may also be available. The test program 10 is designed to simulate the task for which the software system 6 is being optimized, and to assign a numerical value to the fitness of the software system's execution of the task simulation. For example, when tuning a database management server for a specific task, the test program 10 might execute a series of SQL (structured query language) statements, and assign a number inversely proportional to the time taken. This number would be returned to the configuration module 4 and used as the score 14.

During initialization, the genetic algorithm engine 2 reads a configuration file 29 that defines an initial genome. This genome includes the names of the parameters to vary, their range, and suggested starting values. By way of example, if the software system 6 is a database management program, a single configuration file entry for a single parameter of the initial genome might be:
BUFFERS 2000 1000 50000,
   where “BUFFERS” refers to the number of buffers allocated to the database buffer pool, “2000” refers to the initial value for the first genome to be tested, “1000” refers to the minimum value that no genome should fall below, and “50000” refers to the allowed maximum value.

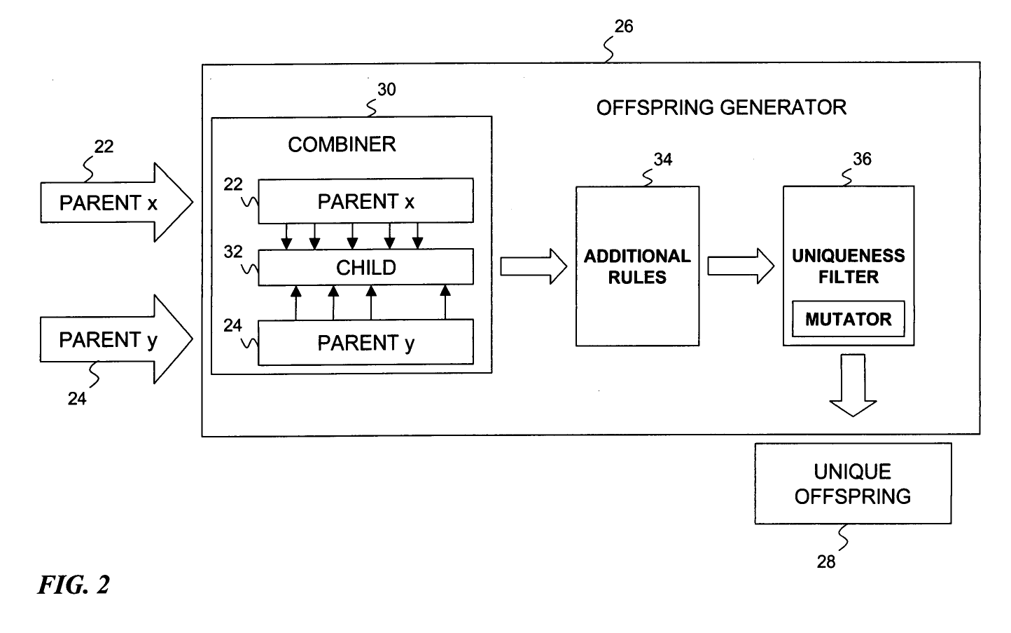

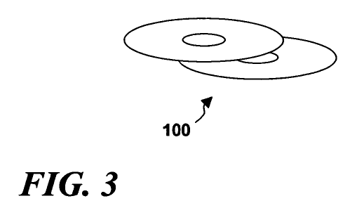

The genetic algorithm engine 2 will also read its own configurable parameters, which affect its selectivity. Examples of such configurable parameters include:
1) Maximum Number of Generations;
2) Maximum score returned by the test program 10 (no further generations necessary when this score reached);
3) Number of offspring per generation;
4) Number of offspring to keep per generation;
5) Number of parents per generation;
6) Variation rate (number of parameters to vary per offspring);
7) Variation amount (preferred change percentage per variation); and
8) Randomness (percentage of offspring that show the preferred variation rate).
   The first three parameters listed above are self-explanatory. The fourth parameter represents the number of offspring genomes to use as parents for future generations and the fifth parameter is the total number of parents to use for the next generation. As an example of how the fourth and fifth parameters interrelate, assume that the number of offspring to keep per generation (parameter 4) is three and the number of parents per generation (parameter 5) is also three. In that case, out of all the genomes that comprise a single generation (parameter 3), three genomes would be used as parents to create the next generation. If, however, the number of offspring to keep per generation (parameter 4) is three and the parents per generation (parameter 5) is four, one additional parent would be needed from outside the current generation and could be selected, for example, from the all-time highest performing genomes. The sixth through eighth parameters set forth above are best discussed with reference to FIG. 2, which shows an exemplary implementation of the offspring generator 26 of FIG. 1.

The offspring generator 26 is shown in FIG. 2 to include a combiner 30 whose function is to generate a child genome 32 by selecting parameter values from the parent genomes 22 and 24. Thus, if there are “c” parameters in each parent genome 22 and 24, the combiner 30 will select “a” parameter values from the parent 22 and “b” parameter values from the parent 24, where a, b and c are numbers and a+b=c. One exemplary algorithm that the combiner 30 may use to perform this function would be to randomly decide for each parameter which parent will contribute the parameter value (“gene”). Another technique would be to bias the selection toward parameters whose values appear to perform better based on overall results. After the child genome 32 is created by the combiner 30, the offspring generator 26 optionally modifies the child by applying additional rules 34. These rules could apply specialist performance knowledge. For example, if a performance expert is certain that one parameter should not go above a certain value when another parameter is above a certain value, this and other system specific relationships could be enshrined as a set of rules that could be applied to alter offspring that do not conform to the rules. Another way offspring can be altered at this point is to apply specific stochastic search and optimization algorithms (of which the genetic algorithm is one type). For example instead of a genetic search, the principles of a simulated annealing search could be used to modify the child parameters toward a desired best case equilibrium condition.

The child genome 32 is passed to a mutator 36 that generates mutations of the child while filtering for uniqueness to ensure there are no duplicate genomes and to improve exploration of the search space. Mutation of the child genome involves making semi-random variations of the parameter values of the child genome to produce additional children of the same two parents 22 and 24. The sixth through eighth parameters of the above-listed configuration parameters are used during this process. The variation rate (parameter 6) refers to the number of parameters to vary per offspring. The variation amount (parameter 7) refers to the preferred change percentage per variation. The randomness parameter (parameter 8) refers to the percentage of offspring that show the preferred variation rate. The mutator 36 can be implemented using a conventional random number generator whose operation is constrained by the above configuration parameters. The output of the offspring generator 26 is the unique offspring genome 28. As indicated above, the offspring generator 26 produces a set of unique offspring 28 for each generation, all of which are mutations of child genomes 32 generated by the combiner 30 and modified by the additional rules 34.

### EXAMPLE

To illustrate the operation of the genetic algorithm engine 2, consider the case where the software system 6 is a Relational Database Management System (RDBMS) and it is desired to tune the RDBMS using three standard tunable configuration parameters. A first tunable parameter named BUFFERS represents the number of buffers allocated to the RDMBS buffer pool. The second tunable parameter named READAHEAD represents the number of prefetch index leafs during long sequential searches. The third tunable parameter named NUMCPUVPS represents the number of CPU virtual processor threads. The initial values of these tunable parameters represent start, min, max values. Set forth below are three exemplary generations of a multigenerational test run that comprises a total of twelve generations. Each numbered genome is associated with a set of parameter values (genes), an execution run time measured in seconds, and a test score. An initial “best guess” genome is used to start the test procedure. A first generation of three genomes is then created based on random changes to individual genomes of the initial genome. Successive generations are created by selecting three pairs of parent genomes from previous generations and producing one child for each parent pair. A final set of parameter, time and test score values is shown following the twelve generations of processing.

Configuration File Entries For Selected Parameters:

BUFFERS 10000 1000 50000
READAHEAD 4 0 512
NUMCPUVPS 3 1 8

Initial Genome:

| Genome | Parameters (Genes) | Execution Time | Score |
|---|---|---|---|
| 1 | 10000, 4, 3 | 125 seconds | 75 |

1^{st} Generation—Based on Random Changes to Individual Genes of Initial Genome:

| Genome | Parameters (Genes) | Execution Time | Score |
|---|---|---|---|
| 2 | 30000, 4, 3 | 117 seconds | 83 |
| 3 | 10000, 4, 1 | 135 seconds | 65 |
| 4 | 10000, 128, 3 | 121 seconds | 79 |

2^{nd} Generation—Based on Children of Parent Genomes 1+2, 2+4 and 1+4:

| Genome | Parameters (Genes) | Execution Time | Score |
|---|---|---|---|
| 5 (1 + 2) | 30000, 4, 4 | 110 seconds | 90 |
| | (BUFFERS from 2, | | |
| | READAHEAD from 1, | | |
| | NUMCPUVPS from 2 but | | |
| | mutated for uniqueness) | | |
| 6 (2 + 4) | 30000, 128, 1 | 115 seconds | 85 |
| | (BUFFERS from 2, | | |
| | READAHEAD from 4, | | |
| | NUMBCPUVPS from 4 | | |
| 7 (1 + 4) | 20000, 128, 3 | 120 seconds | 80 |
| | (BUFFERS from 1 but | | |
| | mutated for uniqueness, | | |
| | READAHEAD from 4, | | |
| | NUMCPUVPS from 4) | | |

3^{rd} Generation—Based on Children of Parent Genomes 5+6, 5+2 and 6+7:

| Genome | Parameters (Genes) | Execution Time | Score |
|---|---|---|---|
| 8 (5 + 6) | 30000, 8, 3 | 105 seconds | 95 |
| | (BUFFERS from 5, | | |
| | READAHEAD from 5 but | | |
| | modified for uniqueness, | | |
| | NUMCPUVPS from 6) | | |
| 9 (5 + 2) | 25000, 4, 4 | 103 seconds | 97 |
| | (BUFFERS from 2 but | | |
| | mutated for uniqueness, | | |
| | READAHEAD from 2, | | |
| | NUMBCPUVPS from 5) | | |
| 10 (6 + 7) | 30000, 128, 4 | 107 seconds | 93 |
| | (BUFFERS from 6, | | |
| | READAHEAD from 6, | | |
| | NUMCPUVPS from 7 but | | |
| | mutated for uniqueness) | | |

Final Result—After Twelve Generations:

| Genome | Parameters (Genes) | Execution Time | Score |
|---|---|---|---|
| 37 | 25000, 16, 6 | 43 seconds | 157 |

BUFFERS = 25000
READAHEAD = 16
NUMCPUVPS = 6

It will be appreciated that the foregoing example represents only one of many possible processing scenarios in which the present invention could be implemented. Variables such as the number and type of gene for each genome, the number of genomes per generation, the number of generations, and the manner in which parents are selected, children are generated and mutations are created, are all user-definable and may all be adjusted according to user requirements.

Accordingly, a genetic algorithm-based tuning engine has been disclosed. It will be appreciated that the inventive concepts may be variously embodied in any of a data processing system, a machine implemented method, and a computer program product in which programming means are provided by on one or more machine-useable media for use in controlling a data processing system to perform the required functions. Exemplary media for providing such programming means are shown by reference numeral 100 in FIG. 3. The media 100 are shown as being portable optical storage disks of the type that are conventionally used for commercial software sales, such as compact disk-read only memory (CD-ROM) disks, compact disk-read/write (CD-RJW) disks, and digital versatile disks (DVDs). Such media can store the programming means of the invention, either alone or in conjunction with an operating system or other software product that incorporates the required functionality. The programming means could also be provided by portable magnetic media (such as floppy disks), or magnetic media combined with drive systems (e.g. disk drives), or media incorporated in data processing platforms, such as random access memory (RAM), read-only memory (ROM) or other semiconductor or solid state memory. More broadly, the media could comprise any electronic, magnetic, optical, electromagnetic, infrared, semiconductor system or apparatus or device, transmission or propagation medium (such as a network), or other entity that can contain, store, communicate, propagate or transport the programming means for use by or in connection with a data processing system, computer or other instruction execution system, apparatus or device.

Although various embodiments of the invention have been described, it should be apparent that many variations and alternative embodiments could be implemented in accordance with the invention. For example, other genetic algorithm variants may be used in lieu of the techniques described in connection with the exemplary embodiment herein to explore and discover an optimum set of tunable parameters for a software system. It is understood, therefore, that the invention is not to be in any way limited except in accordance with the spirit of the appended claims and their equivalents.

What is claimed is:

1. A system for tuning the performance of a software system, comprising:
a genetic algorithm engine adapted to create a generation of genomes that each represents a set of unique tunable parameter values (genes) associated with said software system;
a configuration module adapted to selectively configure said software system with said genomes;
a test module adapted to selectively execute said software system configured with said genomes and provide a score from each execution to said configuration module; and
said genetic algorithm engine being adapted to combine genomes that have produced meritorious scores to serve as parent genomes and create a next generation of child genomes i having genes selected from each parent genome.

2. A system in accordance with claim 1 wherein said genetic algorithm engine is adapted to iteratively produce multiple generations of genomes and provide said genomes to said configuration module for configuration of said software system and execution of said test program to produce scores corresponding to each generation of genomes.

3. A system in accordance with claim 2 wherein said configuration module is adapted to produce a stored set of last generation scores associated with a most recently executed generation of genomes and to select and store a set of one or more cumulative top scores.

4. A system in accordance with claim 3 wherein said genetic algorithm engine includes a parent selector adapted to select parent genomes from one or both of said last generation score sets and said cumulative top score sets.

5. A system in accordance with claim 4 wherein said genetic algorithm engine further includes a combiner adapted to create child genomes from said parent genomes by selecting genes from each of said parent genomes.

6. A system in accordance with claim 5 wherein said genetic algorithm engine further includes a rule set processor adapted to inspect said child genomes and modify genes thereof that violate established rules.

7. A system in accordance with claim 6 wherein said genetic algorithm engine further includes a uniqueness filter adapted to screen for child genomes having duplicate gene sets.

8. A system in accordance with claim 7 wherein said genetic algorithm engine further includes a mutator adapted to produce mutations of said child genomes by varying genes that comprise said child genomes.

9. A computer program product for tuning the performance of a software system, comprising:
one or more machine-useable media;
means provided by said one or more machine-useable media for programming a data processing platform to operate by implementing:
a genetic algorithm engine adapted to create a generation of genomes that each represent a set of unique tunable parameter values (genes) associated with said software system;
a configuration module adapted to selectively configure said software system with said genomes;
a test module adapted to selectively execute said software system configured with said genomes and provide a score for each execution to said configuration module; and
said genetic algorithm engine being adapted to combine genomes that have produced meritorious scores to serve as parent genomes and create a next generation of child genomes having genes selected from each parent genome.

10. A program product in accordance with claim 9 wherein said genetic algorithm engine is adapted to iteratively produce multiple generations of genomes and provide said genomes to said configuration module for configuration of said software system and execution of said test program to produce scores corresponding to each generation of genomes.

11. A program product in accordance with claim 10 wherein said configuration module is adapted to produce a stored set of last generation scores associated with a most recently executed generation of genomes and to select and store a set of one or more cumulative top scores.

12. A program product in accordance with claim 11 wherein said genetic algorithm engine includes a parent selector adapted to select parent genomes from one or both of said last generation score sets and said cumulative top score sets.

13. A program product in accordance with claim 12 wherein said genetic algorithm engine further includes a combiner adapted to create child genomes from said parent genomes by selecting genes from each of said parent genomes.

14. A program product in accordance with claim 13 wherein said genetic algorithm engine further includes a rule set processor adapted to inspect said child genomes and modify genes thereof that violate established rules.

15. A program product in accordance with claim 14 wherein said genetic algorithm engine further includes a uniqueness filter adapted to screen for child genomes having duplicate gene sets.

16. A program product in accordance with claim 15 wherein said genetic algorithm engine further includes a mutator adapted to produce mutations of said child genomes by varying genes that comprise said child genomes.

17. A method for tuning the performance of a software system comprising:
creating a generation of genomes that each comprise a set of unique tunable parameter values (genes) associated with said software system;
selectively configuring said software system with said genomes;
selectively executing said software system configured with said genomes and generating a score for each execution; and
combining genomes that have produced meritorious scores to serve as parent genomes and creating a next generation of child genomes having genes selected from each parent genome.

18. A method in accordance with claim 17 wherein said method is iterated over multiple generations of genomes, and further includes:
producing a stored set of last generation scores associated with a most recently executed generation of genomes and selecting and storing a set of one or more cumulative top scores;
selecting parent genomes from one or both of said last generation score sets and said cumulative top score sets;
combining said parent genomes to create child genomes by selecting genes from each of said parent genomes;
inspecting said child genomes and modifying genes thereof that violate established rules;
screening for child genomes having duplicate gene sets; and
producing mutations of said child genomes by varying genes that comprise said child genomes.

19. A genetic algorithm engine for tuning the performance of a software system, comprising:
a parent selector adapted to select parent genomes from a group of potential parent genomes, each of said potential parent genomes representing a set of unique tunable parameter values (genes) associated with said software system; and
a combiner adapted to create child genomes from said parent genomes by selecting genes from said parent genomes.

20. A genetic algorithm engine in accordance with claim 19, further including:
a rule set processor adapted to inspect said child genomes and modify genes thereof that violate established rules;
a uniqueness filter adapted to screen for child genomes having duplicate gene sets; and
a mutator adapted to produce mutations of said one or more child genomes by varying genes that comprise said child genomes.
